(19) United States
(12) Patent Application Publication
(10) Pub. No.: US 2017/0118036 A1
(43) Pub. Date: Apr. 27, 2017

(54) INTELLIGENT WIRELESS DIMMING SYSTEM AND METHOD FOR ENVIRONMENT LUMINANCE ADJUSTMENT

(71) Applicant: LUXUL TECHNOLOGY INCORPORATION, New Taipei City (TW)

(72) Inventors: Perng-Fei Yuh, New Taipei City (TW); Shiun-Shang Chan, New Taipei City (TW); Cheng-Hung Pan, New Taipei City (TW)

(21) Appl. No.: 14/983,577

(22) Filed: Dec. 30, 2015

(30) Foreign Application Priority Data
Oct. 27, 2015 (TW) 104135192

(51) Int. Cl. H04L 12/28; H04W 4/00; H04W 76/02

(52) U.S. Cl. CPC H04L 12/2818; H04W 76/023; H04W 4/008

(57) ABSTRACT

An intelligent wireless dimming system includes a mobile device, a lamp control module and a controlled lamp. The device has an application program installed therein. Connectivity is established between the mobile device and the lamp control module. Configured environmental luminance can be set up through the mobile device. The mobile device transmits authentication information with a device identifier thereof to the lamp control module through a wireless protocol. The lamp control module adjusts the controlled lamp according to the configured environmental luminance. When detecting a change in environmental luminance, the mobile device transmits a control signal to the lamp control module through the wireless protocol for the lamp control module to adjust luminance of the controlled lamp.

### BACKGROUND OF THE INVENTION

1. Field of the Invention

The present invention relates to a dimming system and a method thereof and, more particularly, to an intelligent wireless dimming system and a method for adjusting environmental luminance using the same dimming system.

1. Description of the Related Art

Metropolitan area is full of high-rise buildings. Lighting is undoubtedly one of the basic equipment required for each office of the buildings. Because users of offices may not be familiar with locations of lamp switches, seeking the lamp switches in the dark could be a challenge to everyone. Sometimes, when users leave the offices with the lights on, additional electrical energy is wasted and the waste inevitably results in a higher operation cost. Currently, the problems of inconvenience caused by manual switching operation of the lights and the energy waste for the sake of inadvertently leaving the lights on still exist.

The disclosure of Taiwan Patent No. 1487303 entitled “Wireless smart energy conservation two-wire lamp control switch device”(hereinafter “the conventional lamp control switch”) introduces a smart wireless peripheral lighting control device for a digital home automation system, which is installed at a single gang wall switch box in a traditional two-wire manner for replacing a traditional manually controlled lamp control switch to three sets of lamp control switches. The conventional lamp control switch internally has a human motion infrared sensor, a visible light illumination sensor, a touch panel, a loading current detector, an environment temperature sensor, and a digital radio transceiving module for receiving commands of remote wireless controller, wireless broadband internet control host or mobile network control host to carry out remote switch lamp control of the lamp set loading. Also, switching lamp control of lamp set can be carried out at a proximal end in a manner of human motion infrared sensing or touch control to replace traditional ways of mechanical press.

As can be seen from the conventional technique, the traditional manually-switching lamp has the issues of insufficient luminance provided by a conventional light source with a fixed luminance when environmental luminance gets dark and inconvenience incurred from manual lamp switching operation. Although the conventional lamp control switch provides multiple sensors in place of manual lamp switching operation, the issue of insufficient luminance upon varied environmental luminance is still left unresolved and the sensors have their limitations, are susceptible to environmental factors, and easily trigger false detection. Accordingly, when natural light exists in the current lighting environment or environmental luminance varies with dynamic change of environmental luminance from dawn to dusk, conventional light sources with a fixed luminance fail to meet users' demands.

### SUMMARY OF THE INVENTION

An objective of the present invention is to provide a method for adjusting environmental luminance using the dimming system and an intelligent wireless dimming system, such that a user can operate a mobile device to transmit a pre-configured or instant luminance information to lamp control equipment for the lamp control equipment to automatically adjust luminance thereof to adapt to environmental luminance.

To achieve the foregoing objective, the intelligent wireless dimming system has a mobile device, at least one lamp control module and at least one controlled lamp, and the method is performed by the intelligent wireless dimming system and includes an automatic configuration mode and an automatic adjustment mode.

The automatic configuration mode has steps of:
transmitting first configuration information and authentication information configured in the mobile device through the mobile device to a corresponding lamp control module; and
when the corresponding lamp control module receives the authentication information, adjusting luminance of a corresponding controlled lamp according to the first configuration information.

The automatic adjustment mode has steps of:
detecting environmental luminance through the mobile device;
when the mobile device determines a change in the environmental luminance according to the second configuration information, transmitting a control signal to the corresponding lamp control module; and
when the corresponding lamp control module receives the control signal, adjusting the luminance of the corresponding controlled lamp according to the control signal.
From the foregoing method, a user can use a mobile device with an application program installed therein to transmit information to the lamp control module through the wireless protocol and the automatic configuration mode and the automatic luminance adjustment mode are performed between the mobile device and the lamp control module. When the automatic configuration mode is performed, the mobile device transmits the first configuration information and the authentication information to the lamp control module for the lamp control module to adjust the luminance of the controlled lamp according to the configured information. When the automatic luminance adjustment mode is performed, the mobile device detects the environmental luminance and determines if a change in the environmental luminance occurs according to the second configuration information. If positive, the mobile device transmits the control signal to the lamp control module for the lamp control module to automatically adjust the luminance of the controlled lamp to adapt to the environmental luminance. Accordingly, operational convenience in luminance adjustment can be attained.

To achieve the foregoing objective, the intelligent wireless dimming system includes a mobile device, at least one lamp control module and at least one controlled lamp.

The mobile device has an application program, a first communication module and a sensor.

The application program is installed in the mobile device.

The first communication module and the sensor serve to edit configured environmental luminance defined to be brighter than preset luminance and transmit a wireless signal through the first communication module according to a wireless protocol.

Each one of the at least one lamp control module has a second communication module connected to the first communication module to receive the wireless signal according to the wireless protocol.

The at least one controlled lamp is connected to the respective lamp control module for the respective lamp control module to adjust luminance of the at least one controlled lamp.

The mobile device transmits preset first configuration information and authentication information including a device identifier to a corresponding lamp control module through the first communication module. When receiving the authentication information through the second communication module, the corresponding lamp control module drives a corresponding controlled lamp to adjust luminance thereof according to the first configuration information. The sensor of the mobile device further detects environmental luminance. When determining a change in the environmental luminance, the mobile device transmits a control signal to the corresponding lamp control module for the corresponding lamp control module to drive the corresponding controlled lamp for luminance adjustment according to the control signal.

As can be seen from the foregoing system architecture, a user can hold the mobile device to walk around each office floor or each office space for luminance adjustment of lights therein. The mobile device just needs to install the application program to edit the configuration information including configured environmental luminance through the application program and wirelessly transmit the configuration information to the lights in the office through the wireless protocol. Specifically, the mobile device transmits the preset first configuration information and the authentication information including a device identifier of the mobile device to the corresponding lamp control module through the first communication module. When the corresponding lamp control module receives the authentication information through the second communication module, the corresponding lamp control module drives the corresponding controlled lamp to adjust luminance of the corresponding controlled lamp. The sensor of the mobile device detects the environmental luminance. When determining a change in the environmental luminance according to the second configuration information, the mobile device transmits a control signal to the corresponding lamp control module for the corresponding lamp control module to drive the corresponding controlled lamp for luminance adjustment according to the control signal. Accordingly, luminance of the controlled lamp can be automatically adjusted to adapt to the environmental luminance and ensure operation convenience.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of an intelligent wireless dimming system in accordance with the present invention;

FIG. 2 is a first operational schematic view of the intelligent wireless dimming system in FIG. 1;

FIG. 3 is a second operational schematic view of the intelligent wireless dimming system in FIG. 1;

FIG. 4 is a third operational schematic view of the intelligent wireless dimming system in FIG. 1; and

FIG. 5 is a sequence diagram of a method for adjusting environmental luminance using the dimming system in FIG. 1.

### DETAILED DESCRIPTION OF THE INVENTION

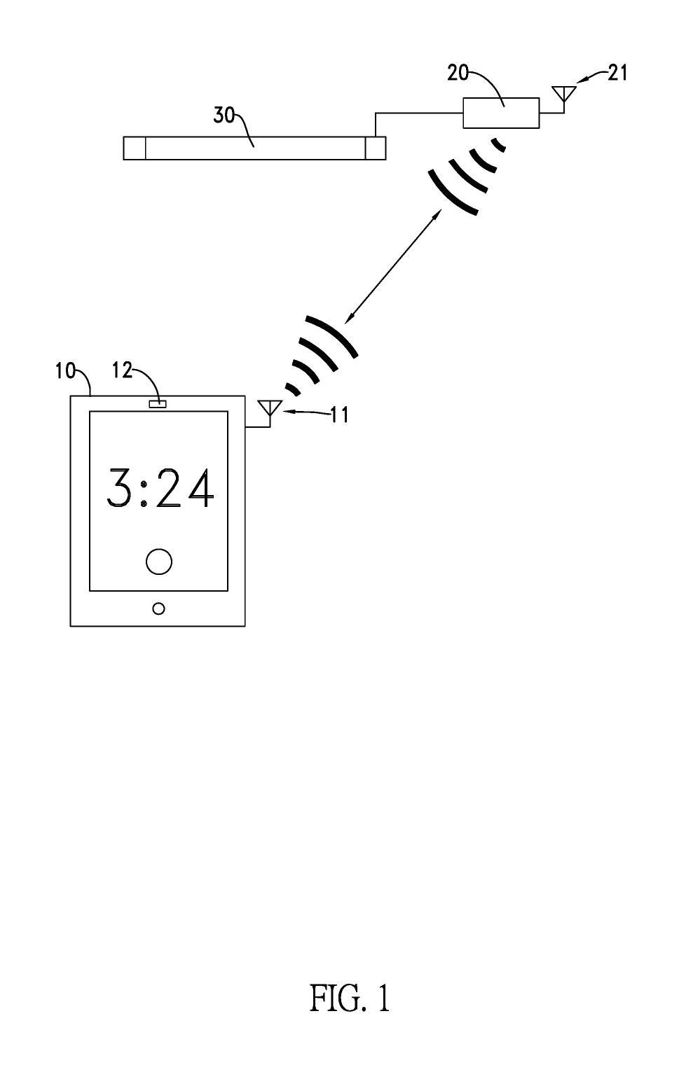

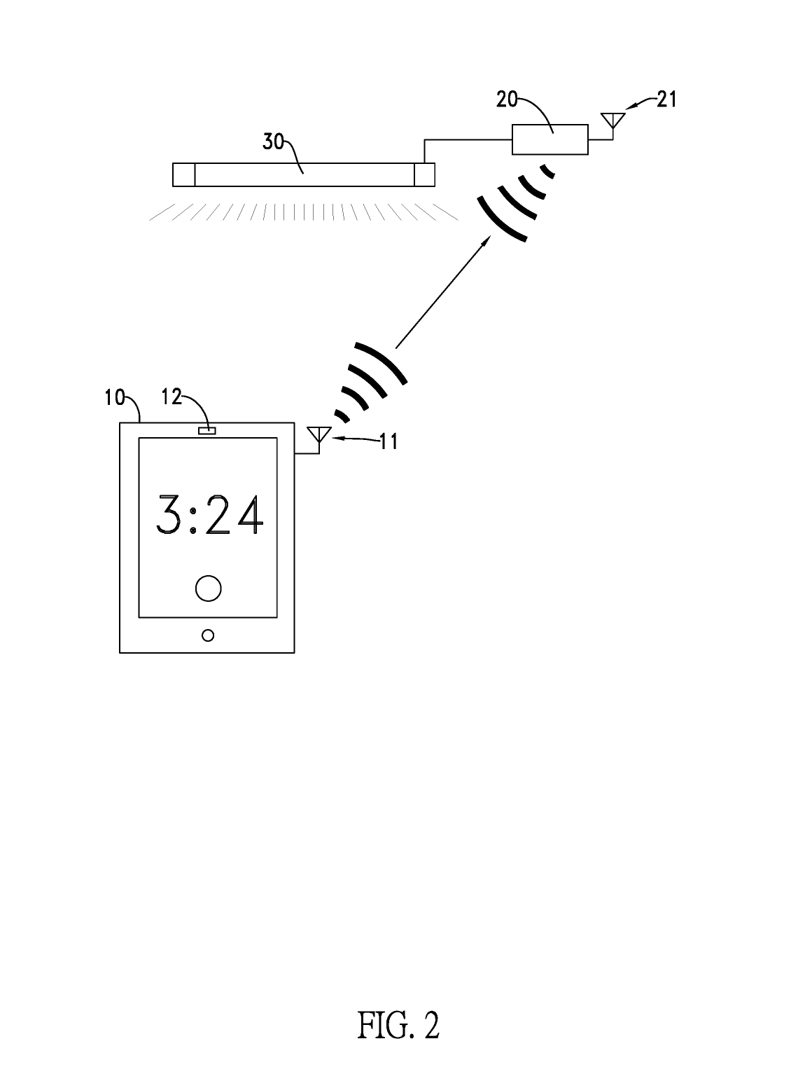

With reference to FIGS. 1 and 2, an intelligent wireless dimming system in accordance with the present invention includes a mobile device 10, at least one lamp control module 20 and at least one controlled lamp 30. Users hold the mobile device 10 to wirelessly connect to the at least one controlled lamp 30. Each one of the at least one lamp control module 20 is connected to a corresponding controlled lamp 30 to adjust luminance of the controlled lamp 30.

The mobile device 10 has a dedicated application program installed on the mobile device 10, and includes a first communication module 11 and a sensor 12. The mobile device 10 is operated through the application program to edit and configure setting information including configured environmental luminance. The configured environmental luminance is defined to be brighter than preset luminance. The first communication module 11 is connected to the corresponding controlled lamp 20 through a wireless protocol to transmit information. In the present embodiment, the sensor 12 is an image sensor.

Each lamp control module 20 has a second communication module 21. The second communication module 21 is connected to the mobile device 10 through the wireless protocol. In the present embodiment, each of the first communication module 11 and the second communication module 21 is a WiFi (Wireless Fidelity) module or a Bluetooth® module, and the wireless protocol is a WiFi protocol or a Bluetooth® protocol.

When a user carries the mobile device 10 to walk to each office floor or each office space, it is frequent that at least one lamp control module 20 and at least one controlled lamp 30 are installed on the office floor or the office space to provide lighting. With reference to FIG. 1, when the user's mobile device is not approaching or the dedicated application program is not executed, the at least one lamp control module 20 has not established connection with the mobile device 10, such that the at least one controlled lamp 30 in connection with the respective lamp control module is not activated. When the user is approaching or heading for an office intended to be used and the dedicated application program is installed in the mobile device 10, the user can launch the application program to instantly edit the setting information for configured environmental luminance, perform automatic wireless communication and adjust the at least one controlled lamp 30 to provide adequate lighting.

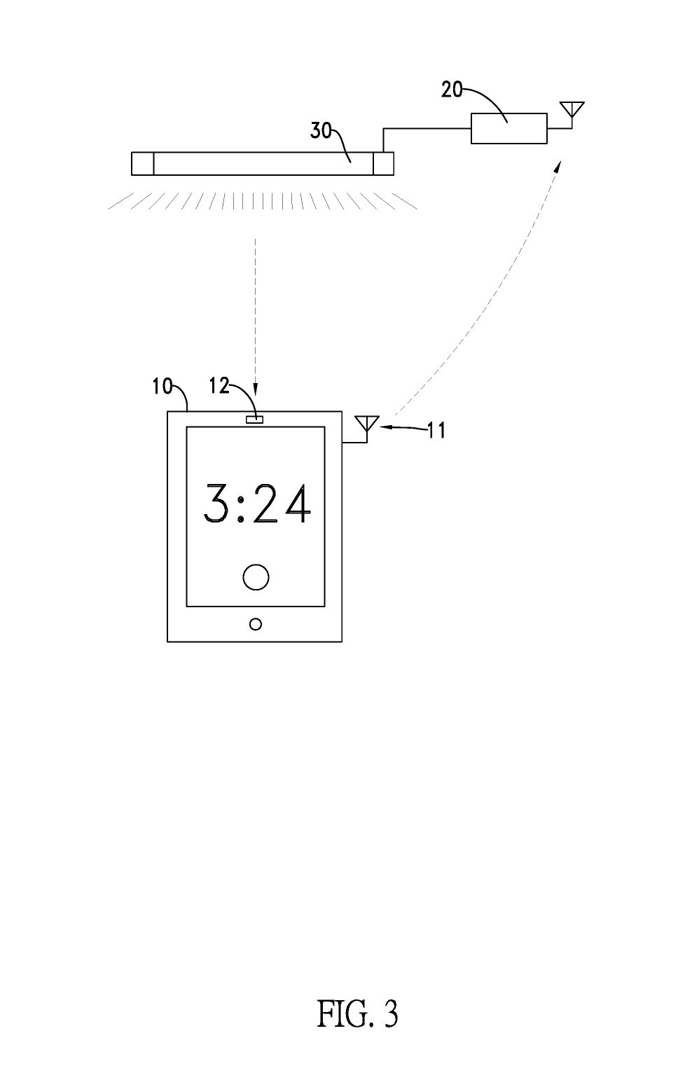

With reference to FIGS. 2 and 3, the user launches the dedicated application program in the mobile device 10 and establishes connection with the corresponding lamp control module 20 and transmits authentication information including first configuration information and a mobile device identifier (Unique Device Identifier, UDID) through the mobile device 10. The authentication information is forwarded to the corresponding lamp control module 20 through the first communication module 11 for the corresponding lamp control module 20 to perform dimming control based on the authentication information of the mobile device 10. When receiving the authentication information through the second communication module 21, the corresponding lamp control module 20 can drive the controlled lamp connected therewith to adjust luminance of the controlled lamp.

When natural light exists in an environment or luminance of the environment dynamically varies throughout the day, the user can use the mobile device 10 to detect the luminance of the environment through the sensor 12. When determining that the luminance of the environment is changed according to second configuration information, the mobile device 10 transmits a control signal to the lamp control module 20 through the wireless protocol and the lamp control module 20 further drives the controlled lamp 30 to adjust luminance of the controlled lamp 30 according to the control signal. In the present embodiment, each of the first configuration information and the second configuration information is a luminance value. The first configuration information may be greater than or equal to the second configuration information. Alternatively, the first configuration information may be less than or equal to the second configuration information.

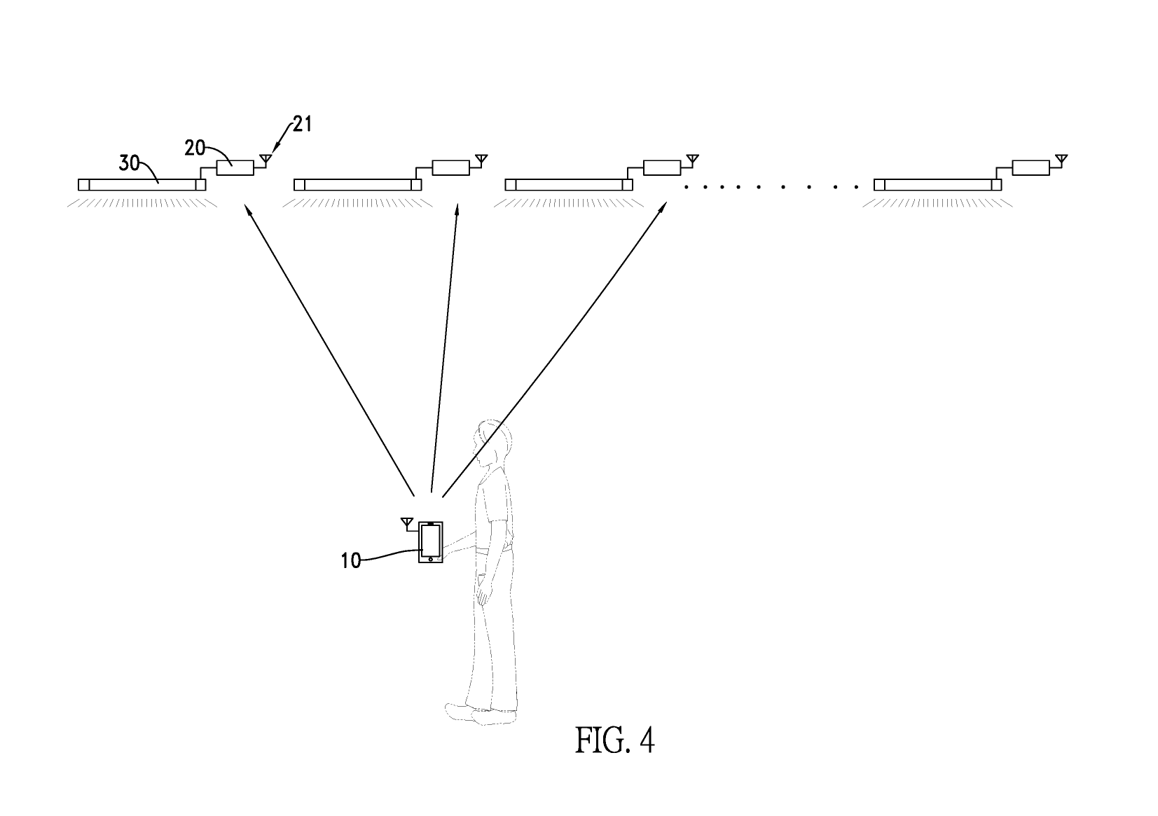

With reference to FIG. 4, each office floor or each office can be equipped with multiple lamp control modules 20 and multiple controlled lamps 30. The multiple lamp control modules 20 and the multiple controlled lamps 30 constitute multiple sets of light sources. The luminance of the multiple sets of light sources is adjusted according to the first configuration information in the mobile device 10. When a user carries the mobile device 10 and approaches one set of the multiple sets of light sources, the luminance of the set of light source is adjusted by walking around in consideration of environmental luminance detected by the sensor 12 of the mobile device 10. The occasion of the mobile device 10 determining the environmental luminance for luminance adjustment takes place when the environmental luminance is less than the first configuration information or the second configuration information, such as the configured environmental luminance, the dedicated application program in the mobile device 10 is launched to transmit the configuration information based on the wireless protocol and informs the lamp control module 20 to raise luminance and drive the controlled lamp 30 to adjust luminance of the set of light source to be brighter. When the environmental luminance is greater than the first configuration information or the second configuration information, the mobile device 10 informs the lamp control module 20 to lower luminance and drive the controlled lamp 30 to dim the set of light source. When the environmental luminance is equal to the first configuration information or the second configuration information, the luminance adjustment is stopped to maintain the configured environmental luminance. When the wireless signal transmitted from the mobile device 10 to the lamp control module 20 has signal intensity lower than a threshold value, the lamp control module 20 then determines that the user has walked away and turns off the controlled lamp 30.

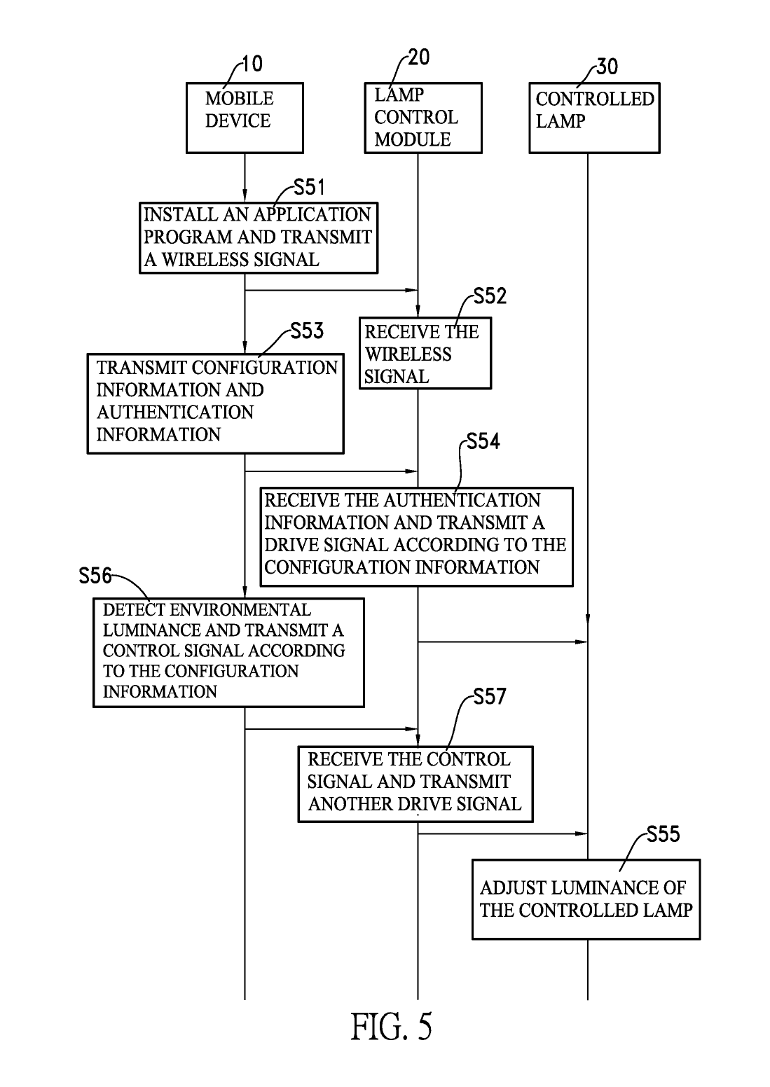

With reference to FIG. 5, a method for adjusting environmental luminance using the foregoing intelligent wireless dimming system in accordance with the present invention is performed by the intelligent wireless dimming system and includes the following steps.

Step S51: Transmit a wireless signal through the dedicated application program installed in the mobile device 10 according to the wireless protocol.

Step S52: Receive the wireless signal through a corresponding lamp control module 20 for the corresponding lamp control module 20 to be connected with the mobile device 10 and the corresponding lamp control module 20.

The method provides an automatic configuration mode and an automatic adjustment mode. During the automatic configuration mode, the method further includes the following steps.

Step S53: Transmit the first configuration information and the authentication information to the corresponding lamp control module 20 through the mobile device. In the present embodiment, the authentication information includes a mobile device identifier (UDID) and the wireless protocol is a WiFi protocol or a Bluetooth® protocol.

Step S54: When the corresponding lamp control module 20 receives the authentication information, transmit a drive signal to a corresponding controlled lamp 30 through the corresponding lamp control module 20.

Step S55: Adjust luminance of light emitted from the corresponding controlled lamp 30 according to the drive signal.

During the automatic adjustment mode, the method further includes the following steps.

Step S56: Detect environmental luminance through the sensor 12 of the mobile device 10 for the mobile device 10 to determine a change in the environmental luminance according to the second configuration information and transmit a control signal to the corresponding lamp control module 20. In the present embodiment, each of the first configuration information and the second configuration information is a luminance value. The first configuration information may be greater than or equal to the second configuration information. Alternatively, the first configuration information may be less than or equal to the second configuration information.

Step S57: When the corresponding lamp control module 20 receives the control signal, transmit another drive signal to the corresponding controlled lamp 30 for the corresponding controlled lamp 30 to adjust luminance of light emitted from the corresponding controlled lamp 30.

In the present embodiment, the way of adjusting environmental luminance in step S56 is performed as follows. When the mobile device 10 determines that the environmental luminance is less than the first configuration information or the second configuration information, such as the configured environmental luminance, the dedicated application program in the mobile device 10 is launched to transmit the configuration information based on the wireless protocol and informs the lamp control module 20 to raise luminance and drive the controlled lamp 30 to adjust luminance of the set of light source to be brighter. When the environmental luminance is greater than the first configuration information or the second configuration information, the mobile device 10 informs the lamp control module 20 to lower luminance and drive the controlled lamp 30 to dim the set of light source.

Additionally, the method further includes a step of turning off the corresponding controlled lamp 30 when the signal intensity of the wireless signal transmitted from the mobile device 10 and received by the corresponding controlled lamp 30 is less than a threshold value, or turning off the corresponding controlled lamp 30 after expiration of a wait time when the corresponding lamp control module 20 loses track of the wireless signal transmitted from the mobile device 10.

Given the foregoing embodiments of the intelligent wireless dimming system and the method for adjusting environmental luminance using the dimming system, insufficient luminance provided by a conventional light source with a fixed luminance when environment luminance gets dark, the inconvenience incurred from manual lamp switching operation, and false detection can be tackled. When natural light exists in an environment or luminance of the environment dynamically varies throughout the day, the present invention automatically adjusts luminance of the controlled lamp to keep environmental luminance in a uniform fashion and enhance operational convenience.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for adjusting environmental luminance using an intelligent wireless dimming system, wherein the intelligent wireless dimming system has a mobile device, at least one lamp control module and at least one controlled lamp, the method performed by the intelligent wireless dimming system and comprising an automatic configuration mode and an automatic adjustment mode, wherein
the automatic configuration mode comprises steps of:
transmitting first configuration information and authentication information configured in the mobile device through the mobile device to a corresponding lamp control module according to a wireless protocol; and
when the corresponding lamp control module receives the authentication information, adjusting luminance of a corresponding controlled lamp according to the first configuration information; and
the automatic adjustment mode comprises steps of:
detecting environmental luminance through the mobile device;
when the mobile device determines a change in the environmental luminance according to the second configuration information, transmitting a control signal to the corresponding lamp control module; and
when the corresponding lamp control module receives the control signal, adjusting the luminance of the corresponding controlled lamp according to the control signal.

2. The method as claimed in claim 1, wherein the step of when the mobile device determines the change in the environmental luminance according to the second configuration information, transmitting a control signal to the corresponding lamp control module further comprises a step of when the mobile device determines that the environmental luminance is less than one of the first configuration information and the second configuration information, informing the corresponding lamp control module to raise the luminance of the corresponding controlled lamp.

3. The method as claimed in claim 1, wherein the step of when the mobile device determines the change in the environmental luminance according to the second configuration information, transmitting a control signal to the corresponding lamp control module further comprises a step of when the mobile device determines that the environmental luminance is greater than one of the first configuration information and the second configuration information, informing the corresponding lamp control module to lower the luminance of the corresponding controlled lamp.

4. The method as claimed in claim 1, further comprising a step of when the lamp control module determines that a wireless signal transmitted from the mobile device to the corresponding lamp control module has signal intensity lower than a threshold value, turning off the corresponding controlled lamp.

5. The method as claimed in claim 1, further comprising a step of when the corresponding lamp control module loses track of a wireless signal transmitted from the mobile device, turning off the corresponding controlled lamp after expiration of a wait time.

6. The method as claimed in claim 1, wherein the authentication information has a mobile device identifier, the wireless protocol is one of WiFi (Wireless Fidelity) protocol and a Bluetooth® protocol, and each of the first configuration information and the second configuration information is a luminance value.

7. The method as claimed in claim 2, wherein the authentication information has a mobile device identifier, the wireless protocol is one of WiFi (Wireless Fidelity) protocol and a Bluetooth® protocol, and each of the first configuration information and the second configuration information is a luminance value.

8. The method as claimed in claim 3, wherein the authentication information has a mobile device identifier, the wireless protocol is one of WiFi (Wireless Fidelity) protocol and a Bluetooth® protocol, and each of the first configuration information and the second configuration information is a luminance value.

9. The method as claimed in claim 4, wherein the authentication information has a mobile device identifier, the wireless protocol is one of WiFi (Wireless Fidelity) protocol and a Bluetooth® protocol, and each of the first configuration information and the second configuration information is a luminance value.

10. The method as claimed in claim 5, wherein the authentication information has a mobile device identifier, the wireless protocol is one of WiFi (Wireless Fidelity) protocol and a Bluetooth® protocol, and each of the first configuration information and the second configuration information is a luminance value.

11. The method as claimed in claim 6, wherein the first configuration information is less than or equal to the second configuration information.

12. The method as claimed in claim 7, wherein the first configuration information is greater than or equal to the second configuration information.

13. The method as claimed in claim 8, wherein the first configuration information is greater than or equal to the second configuration information.

14. The method as claimed in claim 9, wherein the first configuration information is greater than or equal to the second configuration information.

15. The method as claimed in claim 10, wherein the first configuration information is greater than or equal to the second configuration information.

16. The method as claimed in claim 6, wherein the first configuration information is less than or equal to the second configuration information.

17. The method as claimed in claim 7, wherein the first configuration information is less than or equal to the second configuration information.

18. The method as claimed in claim 8, wherein the first configuration information is less than or equal to the second configuration information.

19. The method as claimed in claim 9, wherein the first configuration information is less than or equal to the second configuration information.

20. The method as claimed in claim 10, wherein the first configuration information is less than or equal to the second configuration information.

21. An intelligent wireless dimming system, comprising:
a mobile device having:
an application program installed in the mobile device; and
a first communication module and a sensor serving to edit configured environmental luminance defined to be brighter than preset luminance and transmitting a wireless signal through the first communication module according to a wireless protocol;
at least one lamp control module, each one of the at least one lamp control module having a second communication module connected to the first communication module to receive the wireless signal according to the wireless protocol; and
at least one controlled lamp connected to the respective lamp control module for the respective lamp control module to adjust luminance of the at least one controlled lamp;
wherein the mobile device, the at least one lamp control module and the at least one controlled lamp execute an automatic configuration mode and an automatic adjustment mode;
the automatic configuration mode comprises steps of:
transmitting first configuration information and authentication information configured in the mobile device through the mobile device to a corresponding lamp control module according to a wireless protocol; and
when the corresponding lamp control module receives the authentication information, adjusting luminance of a corresponding controlled lamp according to the first configuration information; and
the automatic adjustment mode comprises steps of:
detecting environmental luminance through the mobile device;
when the mobile device determines a change in the environmental luminance according to the second configuration information, transmitting a control signal to the corresponding lamp control module; and
when the corresponding lamp control module receives the control signal, adjusting the luminance of the corresponding controlled lamp according to the control signal.

22. The intelligent wireless dimming system as claimed in claim 21, wherein the step of when the mobile device determines the change in the environmental luminance according to the second configuration information, transmitting a control signal to the corresponding lamp control module further comprises a step of when the mobile device determines that the environmental luminance is less than one of the first configuration information and the second configuration information, informing the corresponding lamp control module to raise the luminance of the corresponding controlled lamp.

23. The intelligent wireless dimming system as claim 21, wherein the step of when the mobile device determines the change in the environmental luminance according to the second configuration information, transmitting a control signal to the corresponding lamp control module further comprises a step of when the mobile device determines that the environmental luminance is greater than one of the first configuration information and the second configuration information, informing the corresponding lamp control module to lower the luminance of the corresponding controlled lamp.

24. The intelligent wireless dimming system as claimed in claim 21, wherein the automatic adjustment mode further comprises a step of when the lamp control module determines that a wireless signal transmitted from the mobile device to the corresponding lamp control module has signal intensity lower than a threshold value, turning off the corresponding controlled lamp.

25. The intelligent wireless dimming system as claimed in claim 21, wherein the automatic adjustment mode further comprises a step of comprising a step of when the corresponding lamp control module loses track of a wireless signal transmitted from the mobile device, turning off the corresponding controlled lamp after expiration of a wait time.

26. The intelligent wireless dimming system as claimed in claim 21, wherein the authentication information has a mobile device identifier, the wireless protocol is one of WiFi (Wireless Fidelity) protocol and a Bluetooth® protocol, and each of the first configuration information and the second configuration information is a luminance value.

27. The intelligent wireless dimming system as claimed in claim 21, wherein the first configuration information is less than or equal to the second configuration information.

28. The intelligent wireless dimming system as claimed in claim 21, wherein the first configuration information is greater than or equal to the second configuration information.

29. The intelligent wireless dimming system as claimed in claim 21, wherein the first communication module is one of a WiFi (Wireless Fidelity) module and a Bluetooth® module, the second communication module is one of a WiFi module and a Bluetooth® module, and the sensor is an image sensor.

30. The intelligent wireless dimming system as claimed in claim 22, wherein the first communication module is one of a WiFi (Wireless Fidelity) module and a Bluetooth® module, the second communication module is one of a WiFi module and a Bluetooth® module, and the sensor is an image sensor.

31. The intelligent wireless dimming system as claimed in claim 23, wherein the first communication module is one of a WiFi (Wireless Fidelity) module and a Bluetooth® module, the second communication module is one of a WiFi module and a Bluetooth® module, and the sensor is an image sensor.

32. The intelligent wireless dimming system as claimed in claim 24, wherein the first communication module is one of a WiFi (Wireless Fidelity) module and a Bluetooth® module, the second communication module is one of a WiFi module and a Bluetooth® module, and the sensor is an image sensor.

33. The intelligent wireless dimming system as claimed in claim 25, wherein the first communication module is one of a WiFi (Wireless Fidelity) module and a Bluetooth® module, the second communication module is one of a WiFi module and a Bluetooth® module, and the sensor is an image sensor.

34. The intelligent wireless dimming system as claimed in claim 26, wherein the first communication module is one of a WiFi (Wireless Fidelity) module and a Bluetooth® module, the second communication module is one of a WiFi module and a Bluetooth® module, and the sensor is an image sensor.

35. The intelligent wireless dimming system as claimed in claim 27, wherein the first communication module is one of a WiFi (Wireless Fidelity) module and a Bluetooth® module, the second communication module is one of a WiFi module and a Bluetooth® module, and the sensor is an image sensor.

36. The intelligent wireless dimming system as claimed in claim 28, wherein the first communication module is one of a WiFi (Wireless Fidelity) module and a Bluetooth® module, the second communication module is one of a WiFi module and a Bluetooth® module, and the sensor is an image sensor.
